(19) United States
(12) Patent Application Publication
(10) Pub. No.: US 2005/0039556 A1
(43) Pub. Date: Feb. 24, 2005

(54) Rotational apparatus

(76) Inventor: David Andrew Nowlan, Surrey (CA)

Correspondence Address: OYEN, WIGGS, GREEN & MUTALA;480 - THE STATION, 601 WEST CORDOVA STREET, VANCOUVER, BC, V6B 1G1, CA

(21) Appl. No.: 10/920,290

(22) Filed: Aug. 18, 2004

Related U.S. Application Data
(60) Provisional application No. 60/496,403, filed on Aug. 20, 2003.

(51) Int. Cl. F16H 33/20

(52) U.S. Cl. 74/84 S

(57) ABSTRACT

Apparatus are provided for using rotational motion to obtain linear force. A pair of masses are coupled to opposing ends of a rod and rotated about a quasi-elliptical primary orbit. A primary mass is constrained to move about the primary orbit by a suitably shaped primary guide. The rod is coupled to a sliding/pivoting joint, so that the rod may slide radially inwardly and outwardly as the primary mass moves along the primary guide. The radial motion of the rod creates unbalanced centripetal forces which result in reaction forces. Over the course of a full rotation, the reaction forces add to provide a linear force in a desired direction. An apparatus for tractionless propulsion may comprise one or more pairs of such mechanisms. An apparatus for energy extraction may also be provided by rotating the rod and the pair of masses using a magnetic system comprising suitably shaped and suitably located magnets.

### CROSS-REFERENCE TO RELATED APPLICATIONS

This application claims the benefit of the filing date of U.S. patent application Ser. No. 60/496,403 filed 20 Aug. 2003.

### TECHNICAL FIELD

The invention relates to rotational energy and to methods and apparatus for exploiting rotational energy.

### BACKGROUND

Newton's first law of motion states that every body continues to move in a state of uniform speed in a straight line, unless it is compelled to change that state by external forces acting on it. In compliance with Newton's first law, an object (A) traveling in an arc-shaped path exhibits acceleration directed towards the center of curvature of the arc-shaped path. This acceleration of the object (A) is referred to as centripetal acceleration and is represented mathematically by a_{c}=ω²r (“Equation (1)”), where a_{c} is the centripetal acceleration, ωis the angular velocity (in radians/sec) and r is the instantaneous length of the radius of curvature. The corresponding centripetal force is given by F_{c}=ma_{c} (“Equation (2)”), where m is the mass of the object (A). This centripetal force (F_{c}) must be applied to the object (A) in order to keep it traveling in the arc-shaped path. The kinetic energy of an object traveling on such a path is given by KE=½Iω² (“Equation (3)”), where I is the moment of inertia of the object (A).

Newton's third law of motion states that for every action, there is an equal and opposite reaction. In terms of rotational motion of the object (A) traveling along an arc-shaped path, Newton's first law requires that a centripetal force (F_{c}) be applied to the object (A). For example, this centripetal force (F_{c}) could be applied to object (A) by another object (B). In such a case, Newton's third law requires that object (A) exert an equal and opposite reaction force to object (B). This force applied by object (A) to object (B) during the movement of object (A) along an arc-shaped path is referred to in this description as a “reaction force”.

Patent literature relating to energy, acceleration and force(s) associated with rotational motion includes:
U.S. Patent Application Publication 2001/0004098A1 (Smith et al.) discloses a thrust levitation mechanism having a plurality of lifting rotors located about the periphery thereof. The thrust mechanism may be used to induce movement in vehicles;
Japanese Patent Abstract JP1107905A2 (Takeshi) discloses a centrifugal force extraction device, wherein an object is rotated at constant speed and is moved to the center of circle or toward an opposite side to create an unbalanced centrifugal force which is utilized as propulsion force;
European Patent Application EP0878639A3 (Fujita et al.) discloses an energy extraction mechanism comprising a magnetic spring, wherein a pair of permanent magnets may be rotated relative to one another to provide energy;
Japanese Patent Abstract JP2001107840A2 (Masahiko) discloses a device for converting centrifugal force into propulsive force, wherein a cylinder rail is rotated about an adjustable orbital ring;
European Patent Application EP1213477A1 (Bronislavovich) teaches a technique for converting rotation of a solid body into a linear traction force by disbalancing the rotation of the solid body;
United Kingdom Patent Application GB2019110A (Jimenez) describes a magnetically driven rotating machine having a plurality of curvilinear shaped magnets housed in a particular geometric arrangement in a stator and a similarly arranged plurality of magnets in a corresponding rotor;
U.S. Pat. No. 6,504,285B2 (Yun) discloses a motor which employs vector motion principles to convert magnetic forces into rotary motion using a rotor with a shaft and a plurality of magnets connected to the shaft by bent supports;
European Patent Specification EP0128008B1 and U.S. Pat. No. 4,631,971 (Thornson) describe an apparatus for generating propulsion, which comprises a pair of oppositely driven symmetrical wheels mounted in the same plane for rotation about parallel axes at right angles to the plane;
U.S. Pat. No. 3,683,707 (Cook) teaches a propulsion system operative to propel a vehicle along a linear path by changing the position of the center of gravity of a rotatably driven weight, which is subdivided into two counter-rotating mass members;
U.S. Pat. No. 4,238,968 (Cook) describes a device for conversion of centrifugal force to linear force, which utilizes a pair of arms that rotate in opposite directions about a common axle; and
U.S. Pat. No. 5,436,516 (Yamazaki) teaches an inertial device for energy storage, comprising a first object with a rotational mechanism and a surface that generates a magnetic field, a second superconducting object that generates a magnetic field, a device that provides rotational energy to the first object and a device which converts the rotational energy of the first object into electrical energy.

Because of various disadvantages, none of these prior art systems have been able to achieve their objectives in a commercially feasible manner. It is desirable therefore to provide methods and apparatus for obtaining linear force from rotational motion in a manner that ameliorates at least some of the disadvantages of the prior art. It is similarly desirable to provide methods and apparatus for extracting energy from rotational motion.

### SUMMARY OF THE INVENTION

One aspect of the invention provides an apparatus for converting rotational motion into linear force. The apparatus comprises a rod having a primary end and an opposing secondary end. The rod is rotatable about a pivot joint and translatable relative to the pivot joint. The apparatus also comprises a guide coupled to the primary end for constraining motion of the primary end to a particular orbit around the pivot joint. The particular orbit has a first region shaped wherein when the primary end is located in the first region, a moment of inertia of the primary end is greater than a moment of inertia of the secondary end. The apparatus also comprises an energy introduction mechanism for causing rotation of the rod about the pivot joint. Rotation of the rod about the pivot joint causes unbalanced centripetal forces which result in reaction forces exerted by the primary end on the guide. Over the course of a full rotation, the reaction forces add to provide a linear force in a desired direction.

The first region may comprise first and second subregions. The first subregion may be shaped such that as the primary end moves through the first sub-region in a particular direction, a distance between the pivotal joint and the orbit increases. Conversely, the second subregion may be shaped such that as the rod moves through the second subregion in the particular direction, a distance between the pivotal joint and the orbit decreases. The energy introduction mechanism may comprise a motor coupled to rotate the rod about the pivot joint. The orbit may be substantially elliptical in shape and the pivot joint may be located at a focal point of the elliptical orbit.

The rod may comprises a primary mass at the primary end thereof and a secondary mass at a secondary end thereof. The primary mass and the secondary mass may be equal.

The guide may comprise a magnetically permeable material. The apparatus may comprise a coupling mechanism for coupling the primary mass to the guide. The coupling mechanism may have a bearing in contact with the guide and at least one permanent magnet. The permanent magnet may be oriented to create a magnetic force on the magnetically permeable material that tends to reduce frictional force between the bearing and the guide over at least a portion of the orbit. The coupling mechanism may comprise a pivotal joint for allowing pivotal motion of the primary mass with respect to the primary end. The bearing may contact the guide on an inward surface thereof and the permanent magnet may be located on an outward side of the guide.

The apparatus may comprise another type of coupling mechanism for coupling the primary mass to the guide. The coupling mechanism may comprise an outward permanent magnet located on an outward side of the guide, an inward permanent magnet located on an inward side of the guide, at least one outward bearing in contact with the outward side of the guide for a first portion of the orbit and at least one inward bearing in contact with the inward side of the guide for a second portion of the orbit. The guide may comprise a magnetically permeable material, which is located on an outward side of the guide in a first portion of the guide corresponding to the first portion of the orbit and the magnetically permeable material located on an inward side of the guide in a second portion of the guide corresponding to the second portion of the orbit. The guide may comprise a non-magnetically permeable material having a thickness greater than the magnetically permeable material, which is located on an inward side of the guide in the first portion of the guide and the non-magnetically permeable material located on an outward side of the guide in the second portion of the guide.

The inward and outward permanent magnets may introduce kinetic energy to the primary mass that is independent of a kinetic energy due to rotation of the primary mass about the orbit. The primary mass may be coupled to a secondary mechanism for harnessing the kinetic energy introduced by the inward and outward permanent magnets. The secondary mechanism may comprise a moment arm of a generator.

The apparatus may be coupled to a secondary mechanism powered by the linear force. The apparatus may be one of a plurality of similar apparatus connected to a common body of a propulsion mechanism.

Another aspect of the invention provides an apparatus for extracting energy from a magnetic field using rotational motion. The apparatus comprises a rod having a primary end and an opposing secondary end. The rod is rotatable about a pivot joint and translatable relative to the pivot joint. The apparatus also comprises a guide coupled to the primary end for constraining motion of the primary end to a particular orbit around the pivot joint. The particular orbit has a first region shaped such that when the primary end is located in the first region, a moment of inertia of the primary end is greater than a moment of inertia of the secondary end. The primary end comprises a magnetically permeable material and the guide comprises one or more permanent magnets located to span at least a portion of the orbit. The one or more permanent magnets are shaped to exert a radially directed force on the primary end. The radially directed force causes the primary end to rotate about the pivot joint and to thereby move about the orbit.

Another aspect of the invention provides an apparatus for obtaining linear force using rotational motion. A pair of masses are coupled to opposing ends of a rod and rotated about a quasi-elliptical primary orbit. A primary mass is constrained to move about the primary orbit by a suitably shaped primary guide. A secondary mass may rotate freely or may be constrained by a suitably shaped secondary guide. The rod is coupled to a sliding/pivoting joint, so that the rod may slide radially inwardly and outwardly as the primary mass moves along the primary guide. The radial motion of the rod creates unbalanced centripetal forces which result in reaction forces that are exerted on the primary guide. Over the course of a full rotation, the reaction forces add to provide a linear force in a desired direction.

The sliding/pivoting joint may comprise suitable bearings, which facilitate sliding motion of the rod, and suitable pivot joints, which facilitate pivotal motion of the rod. The coupling between the primary guide and the primary mass may comprise one or more magnets and one or more bearings to reduce friction. The coupling between the secondary mass and the secondary guide may comprise similar components.

Another aspect of the invention provides an apparatus for propulsion. One or more pairs of the previously described mechanisms may be connected to a common body to implement a smoothly accelerating apparatus for propulsion. The propulsion provided by the apparatus may be tractionless.

Another aspect of the invention provides an apparatus for extracting energy from a magnetic field using rotational motion. The rod and the pair of masses of the previously described mechanism may be rotated using a magnetic system comprising suitably shaped and suitably located permanent magnets. Such permanent magnets may be provided in certain angular regions around the orbit(s) of the primary and/or secondary masses. Alternatively, such permanent magnets may be provided about the entire orbit(s) of the primary and/or secondary masses. Such permanent magnets may exert radially inwardly directed and/or radially outwardly directed forces on the primary and/or secondary masses.

Further features and applications of specific embodiments of the invention are described below.

### BRIEF DESCRIPTION OF THE DRAWINGS

In drawings which depict non-limiting embodiments of the invention:

FIG. 1 is a schematic top plan view of a mechanism for using rotational motion to obtain linear force according to a particular embodiment of the invention;

FIG. 2A is a schematic top plan view of the FIG. 1 mechanism in a different configuration;

FIG. 2B is a vector diagram showing how the FIG. 1 mechanism is balanced when it is in the configuration of FIG. 2A;

FIG. 3A is a schematic top plan view of the FIG. 1 mechanism in a different configuration;

FIG. 3B is a vector diagram showing the reaction force when the FIG. 1 mechanism is in the configuration of FIG. 3A;

FIG. 4 is a schematic representation of a summation of component reaction forces (Fᵣₙ) over one rotational orbit of the FIG. 1 mechanism to obtain a net average reaction force (Fᵣₙₑₜ);

FIG. 5A and 5B are respectively radial cross-sectional and top cross-sectional views of a particular embodiment of a sliding/pivoting joint for use in the FIG. 1 mechanism;

FIG. 6 is a cross-sectional side view of a particular embodiment of a coupling mechanism between the primary mass and the primary guide of the FIG. 1 mechanism;

FIG. 7 is a schematic top plan view of a pair of mechanisms of the type shown in FIG. 1 which may be used to provide a propulsion apparatus according to a particular embodiment of the invention;

FIG. 8 is a schematic partial top plan view of the FIG. 1 mechanism depicting how a magnetic field may provide a radially outwardly oriented force;

FIGS. 9A and 9B are respectively top plan and side cross-sectional views of a particular embodiment of a magnetic system which may be used to rotate the FIG. 1 mechanism and thereby provide an apparatus for energy extraction;

FIG. 10 is a schematic depiction of an alternative embodiment of an apparatus for energy extraction according to the invention; and,

FIG. 11 is a schematic depiction of an alternative embodiment of a magnetic system which may be used to rotate the FIG. 1 mechanism, and to thereby provide an apparatus for energy extraction;

FIGS. 12A and 12B are respectively partial cut-away cross-sectional views of an alternative embodiment of a coupling mechanism between the primary mass and the primary guide;

FIG. 12C is a cross-sectional top view of a mechanism incorporating the coupling mechanism of FIGS. 12A and 12B; and

FIG. 12D is an isometric view of a mechanism incorporating the coupling mechanism of FIGS. 12A and 12B.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

One aspect of the invention relates to an apparatus for using rotational motion to obtain linear force.

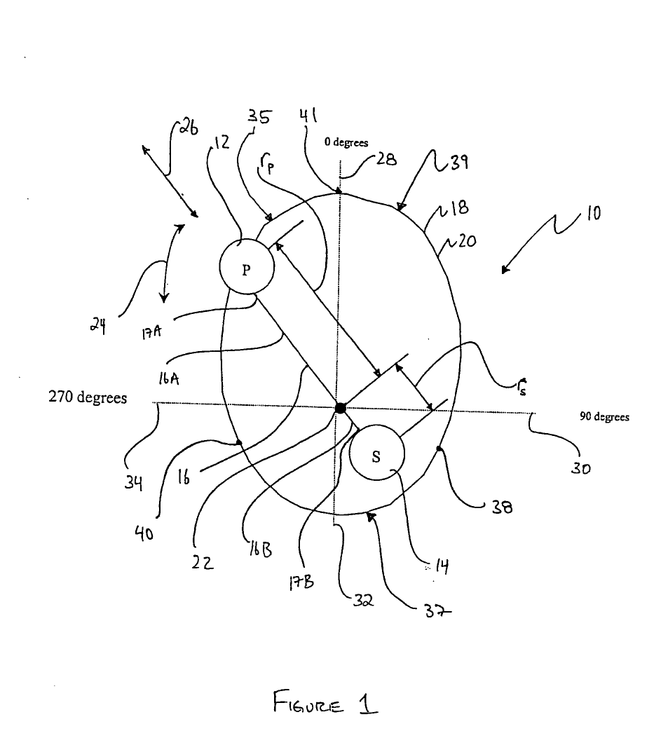

FIG. 1 is a schematic depiction of a mechanism 10 for using rotational motion to obtain linear force according to a particular embodiment of the invention. Mechanism 10 comprises a primary mass 12 and a secondary mass 14, which are respectively provided on primary and secondary ends 17A, 17B of a connector rod 16. Primary mass 12 and secondary mass 14 may have approximately equal masses. Primary mass 12 and secondary mass 14 may be integrally formed on primary and secondary ends 17A, 17B of rod 16. Alternatively, primary and secondary masses 12, 14 may be separate components which are fastened or otherwise connected to the ends 17A, 17B of rod 16. Although not necessarily required to implement the invention, this description assumes, for clarity, that primary mass 12 and secondary mass 14 are equal, except where specifically stated otherwise. Primary mass 12 is constrained to move around primary orbit 18 by a primary guide 20. In the illustrated embodiment, primary orbit 18 (and primary guide 20) are quasi-elliptical in shape. In the FIG. 1 embodiment, secondary mass 14 is not constrained by primary guide 20.

Mechanism 10 comprises a sliding/pivoting joint 22, which allows rod 16 to: (i) pivot about joint 22 in either circumferential direction indicated by double-headed arrow 24; and (ii) slide back and forth in the direction of the elongated axis of rod 16. In the configuration illustrated in FIG. 1, joint 22 allows rod 16 to slide back and forth in the directions indicated by double-headed arrow 26. Further particulars of joint 22 are described below.

A number of directional approximations and conventions are used to facilitate description of this invention. As shown in FIG. 1, primary orbit 18 is quasi-elliptical in shape. The configuration of mechanism 10 and the position of primary mass 12 will be described using angular coordinates of 360 degrees, with the origin being the location of joint 22. For example, in the configuration of FIG. 1, primary mass 12 is positioned at approximately 320 degrees. In FIG. 1, the angular coordinates of 0 degrees, 90 degrees, 180 degrees and 270 degrees are respectively indicated by reference numerals 28, 30, 32 and 34. Despite the fact that primary orbit 18 is quasi-elliptical in shape, the direction of the elongated axis of rod 16 in any given configuration is referred to in this description as the “radial” direction. The radial direction contrasts with the “circumferential” direction which refers to the direction that primary mass moves around primary orbit 18 (i.e. the direction indicated by arrow 24 in FIG. 1). References such as “radially outward”, “radially outwardly” or the like refer to the directions extending radially away from joint 22. Similarly, references such as “radially inward”, “radially inwardly” or the like refer to directions extending radially toward joint 22. References such as “outward ” and “outwardly” or the like refer to directions extending away from mechanism 10, but not necessarily in a radial direction. Similarly, references such as “inward” and “inwardly” or the like refer to directions extending toward mechanism 10 but not necessarily in a radial direction.

A motor (not shown) or other external energy source (e.g. the magnetic systems described below) may be coupled to joint 22 using a suitable coupling mechanism to cause pivotal and/or radial motion of rod 16 and masses 12, 14 about and/or with respect to joint 22. As mentioned above, primary mass 12 is constrained to travel around primary orbit 18 by primary guide 20. Although secondary mass 14 is coupled to secondary end 17B of rod 16, secondary mass 14 may be unconstrained by a guide. As primary mass 12 moves around primary orbit 18, rod 16 slides back and forth through sliding/pivoting joint 22, such that the portion 16A of rod 16 located between primary mass 12 and its center of rotation (joint 22) will vary in length. Similarly, the portion 16B of rod 16 located between secondary mass 14 and its center of rotation (joint 22) will also vary in length as secondary mass 14 rotates around joint 22 in its own uniquely shaped secondary orbit (not shown). It will be appreciated by those skilled in the art, that joint 22 may be defined as the origin of a polar coordinate system and the position of primary mass 12 may be specified (relative to joint 22) by its angular coordinate and the radial position rₚ of its center of mass. Similarly, the position of secondary mass 14 may be specified (relative to joint 22) by its angular coordinate and the radial position r, of its center of mass.

As discussed above, primary orbit 18 and primary guide 20 have a quasi-elliptical shape. The shape of primary orbit 18 may be more particularly described by reference to inflection points 38, 40 and transition point 41. In the illustrated embodiment, inflection points 38, 40 are respectively located at 120 degrees and 240 degrees and transition point 41 is located at 0 degrees. In the angular region 37 between inflection points 38, 39 (i.e. between 120 degrees and 240 degrees in the illustrated embodiment), the radial coordinate of primary orbit 18 is constant. Preferably, the radial coordinate of primary orbit 18 in angular region 37 is approximately equal to half the length of rod 16. In the angular region 35 between inflection point 40 and transition point 41 (i.e. between 240 degrees and 0 degrees in the illustrated embodiment), the radial coordinate of primary orbit 18 increases as primary mass 12 moves in the clockwise direction. Everywhere in angular region 35, however, the radial coordinate of primary orbit 18 is greater than that in angular region 37. In the angular region 39 between transition point 41 and inflection point 38 (i.e. between 0 degrees and 120 degrees in the illustrated embodiment), the radial coordinate of primary orbit 18 decreases as primary mass 12 moves in the clockwise direction. Everywhere in angular region 39, however, the radial coordinate of primary orbit 18 is greater than that in angular region 37.

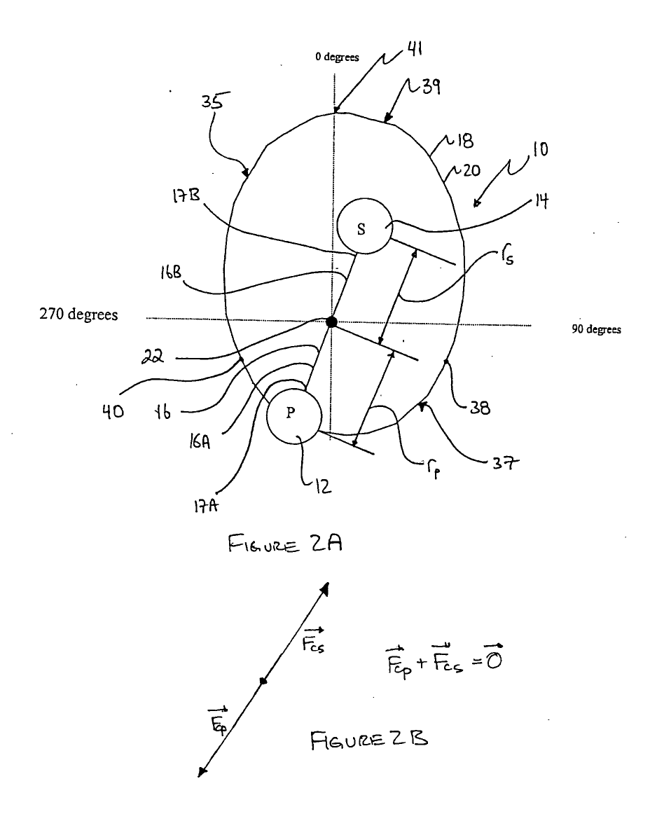

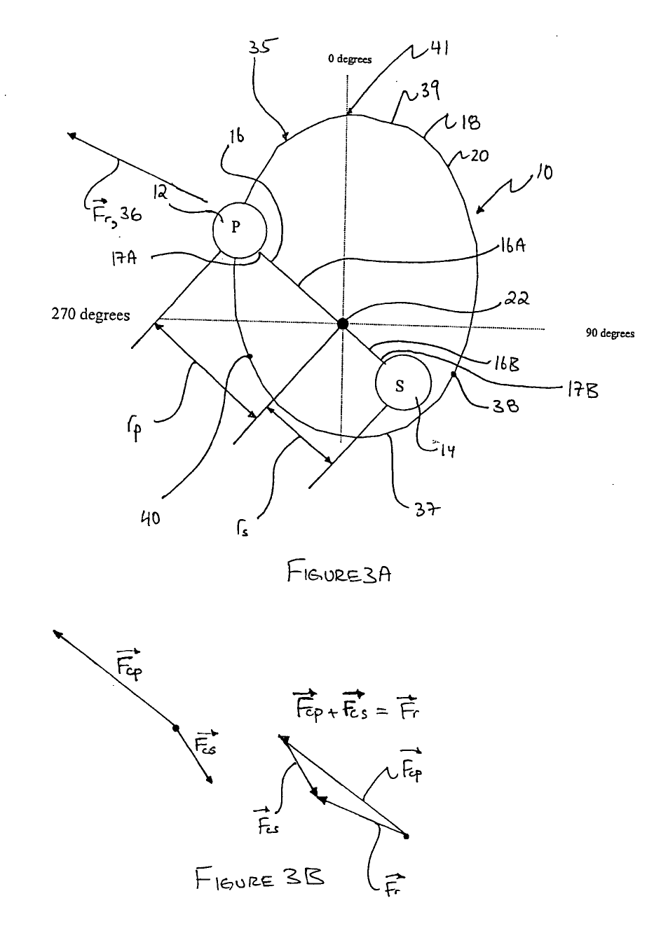

In the illustrated embodiment, primary orbit 18 (and primary guide 20) are shaped such that when primary mass 12 is located in angular region 37 (i.e. between inflection points 38 and 40), the lengths of portions 16A and 16B of rod 16 are approximately equal. That is, the radial coordinate rₚ of primary mass 12 is approximately the same as the radial coordinate rₛ of secondary mass 14. FIG. 2A shows an example of mechanism 10 in such a configuration.

In the configuration of FIG. 2A, primary mass 12 has an angular coordinate of approximately 190 degrees and is thus located in angular region 37, between inflection points 38, 40. In angular region 37, the radial coordinates rₚ, rₛ of primary and secondary masses 12, 14 are approximately equal, the circumferential speeds (ω) of primary and secondary masses 12, 14 are approximately equal and the masses of primary and secondary masses 12, 14 approximately are equal. Accordingly, the centripetal acceleration (a_{c}) of primary and secondary masses 12, 14 will also be equal and opposite (see Equation (1)). Similarly, the centripetal forces (F_{c}) experienced by primary and secondary masses 12, 14 must also be equal and opposite.

When primary mass 12 is located in angular region 37, mechanism 10 is balanced. FIG. 2B depicts the balanced centripetal forces on primary mass 12 (F_{cp}) and secondary mass 14 (F_{cs}) when primary mass is located in angular region 37. The centripetal force (F_{c}) applied to primary mass 12 is balanced by the centripetal force (F_{c}) applied to secondary mass 14. The vector sum of these forces is zero. In other words, the centripetal forces (F_{cp}, F_{cs}) experienced by each of primary and secondary masses 12, 14 is also the reaction force provided by the opposing one of primary and secondary masses 12, 14.

In general, the angular momentum (L) of an object rotating about an arc-shaped orbit is given by the vector cross product L=r×mv (“Equation (4)”), where r is the vector between the axis of rotation and the instantaneous position of the object, m is the mass of the object and v is the linear velocity of the object. In a more general embodiment of mechanism 10, primary and secondary masses 12, 14 need not be equal. In such an embodiment, primary orbit 18 (and primary guide 20) may be shaped and primary and/or secondary masses 12, 14 may be selected, such that, when primary mass 12 is located in angular region 37, the time rate of change of the components of angular momenta (L) of primary and secondary masses 12, 14 in a direction parallel with the axis of rotation are approximately equal. Equivalently, primary orbit 18 (and primary guide 20) may be shaped and/or primary and secondary masses 12, 14 may be selected, such that the moments of inertia of primary and secondary masses 12, 14 are approximately equal when primary mass 12 is located in angular region 37. Such selection of primary guide 20 and primary and secondary masses 12, 14 will achieve the same balanced centripetal forces (F_{cp}, F_{cs}) for mechanism 10 in the general case, where primary mass 12 and secondary mass 14 are not equal.

It is assumed, for the purposes of explaining mechanism 10, that rod 16 is pivoting in a clockwise direction. When rotating in this direction, primary mass 12 will reach inflection point 40, after which it will enter angular region 35, where primary orbit 18 (and primary guide 20) become spaced apart further from joint 22 (i.e. where the radial coordinate rₚ of primary orbit 18 increases). Since primary mass 12 is constrained to move along primary guide 20, primary end 17A of rod 16 will slide radially outwardly through joint 22 as primary mass 12 rotates into and through angular region 35. Consequently, primary mass 12 will slide radially outwardly and secondary mass 14 will slide radially inwardly, such that the portion 16A of rod 16 will lengthen in comparison to the portion 16B of rod 16 and the radial coordinate rₚ of primary mass 12 will become greater than the radial coordinate rₛ of secondary mass 14. FIG. 3A represents an example of such a configuration of mechanism 10, wherein primary mass 12 has an angular coordinate of approximately 300 degrees. When primary mass 12 is located in angular region 35, the radii of curvature for primary and secondary masses 12, 14 are unequal and the centripetal forces acting on primary and secondary masses 12, 14 are unbalanced.

When primary mass 12 is located in angular region 35, the increase in the radius of curvature of primary mass 12 causes a corresponding increase in the centripetal acceleration of primary mass 12 (see Equation (1)). Similarly, the decrease in the radius of curvature of secondary mass 14 causes a corresponding decrease in the centripetal acceleration of secondary mass 14. These unbalanced centripetal accelerations result in unbalanced centripetal forces (F_{cp, F}_{cs}) experienced by primary mass 12 and secondary mass 14 respectively (see Equation (2)).

The centripetal forces (F_{cp}, F_{cs}) are depicted in FIG. 3B. FIG. 3B shows that the directions of centripetal forces (F_{cp}, F_{cs}) are not exactly opposite one another, because, in angular region 35, the center of curvature of primary orbit 18 (i.e. the orbit of primary mass 12) is different than the center of curvature of the orbit of secondary mass 14. Furthermore, these forces (F_{cp}, F_{cs}) are not oriented exactly in the radial direction. According to Newton's third law, however, there must be a reaction force that is equal and opposite to the unbalanced centripetal forces (F_{cp}, F_{cs}). As shown in FIGS. 3A and 3B, this reaction force (Fᵣ) manifests itself as an outwardly directed force. The reaction force (Fᵣ) is exerted on mechanism 10 and will tend to accelerate mechanism 10 outwardly in the direction indicated by arrow 36.

The unbalanced configuration depicted in FIGS. 3A and 3B and explained above occurs throughout the time that primary mass 12 is located within angular region 35. When primary mass 12 enters angular region 39 (between transition point 41 and inflection point 38), the radial coordinate of primary orbit 18 (and primary guide 20) begins to decrease, causing primary end 17A of rod 16 and primary mass 12 to slide radially inwardly through joint 22. However, even when primary mass 12 is located in angular region 39 and its radius of curvature begins to recede, the radius of curvature of primary mass 12 remains larger than radius of curvature of secondary mass 14. Accordingly, when primary mass 12 is located within angular region 39, the centripetal acceleration (a_{c}) of primary mass 12 will always be greater than that of secondary mass 14 (see Equation (1)). In the illustrated embodiment, where primary mass 12 and secondary mass 14 are equal, the centripetal force (F_{cp}) on primary mass 12 will similarly be greater than the centripetal force (F_{cs}) on secondary mass 14 (see Equation (2)), resulting in a reaction force (Fᵣ) that tends to accelerate the entire mechanism 10 outwardly.

Primary guide 20 is preferably smooth and continuously varying (i.e. without discontinuities). However, the shape of primary guide 20 is not limited to the shape depicted in the illustrated embodiment. In general: (i) the angular coordinates of inflection points 38, 40, transition point 41 and angular regions 35, 37, 39 may vary in alternative embodiments of the invention; (ii) angular regions 35, 39 may have other shapes, provided that rₚ>rₛ in angular regions 35, 39; (iii) there may be more than two angular regions wherein rₚ>rₛ; (iv) there may be more than one angular region wherein rₚ=rₛ; and (v) the shape of primary guide 20 may have discontinuities. For example, when used in an apparatus for tractionless propulsion that is designed to move in the direction of 0 degrees, it may be advantageous to provide inflection points 38, 40 at approximately 80 degrees and 280 degrees respectively. This location of inflection points 38, 40 will reduce the reaction force (Fᵣ) components that are directed away from the desired direction of motion.

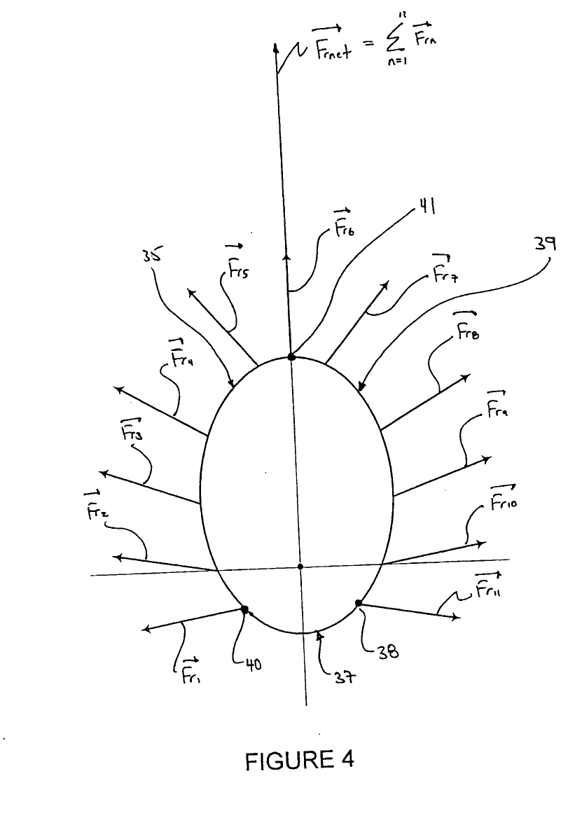

As explained above, there is an outwardly directed reaction force (Fᵣ) when primary mass 12 is in angular regions 35, 39, but mechanism 10 is balanced when primary mass 12 is in angular region 37. With the inflection points 38, 40 located as shown in the illustrated embodiment, integrating (or summing) the reaction force (Fᵣ) over one rotational orbit of primary mass 12, results in a net average reaction force (Fᵣₙₑₜ), which is a non-zero force in the angular direction of approximately 0 degrees. A plurality of representative reaction force component vectors (Fᵣₙ) is illustrated schematically in FIG. 4. Although FIG. 4 represents a highly schematic illustration, those skilled in the art will appreciate that because of the symmetry of primary guide 20 and primary orbit 18, integration (or summation) of the reaction force component rectors (Fᵣₙ) results in the cancellation of transverse components of opposing pairs of reaction force vectors from angular regions 35, 39 (i.e. the transverse components of Fᵣ₁ cancel those of Fᵣ₁₁; the transverse components of Fᵣ₂ cancel those of Fᵣ₁₀; the transverse components of Fᵣ₃ cancel those of Fᵣ₉; the transverse components of Fᵣ₄ cancel those of Fᵣ₈; and, the transverse components of Fᵣ₅ cancel those of Fᵣ₇), leaving a net average reaction force (Fᵣₙₑₜ) in the angular direction of 0 degrees. Those skilled in the art will also appreciate that the net rotational moments arising from these reaction forces (Fᵣₙ) will also be zero.

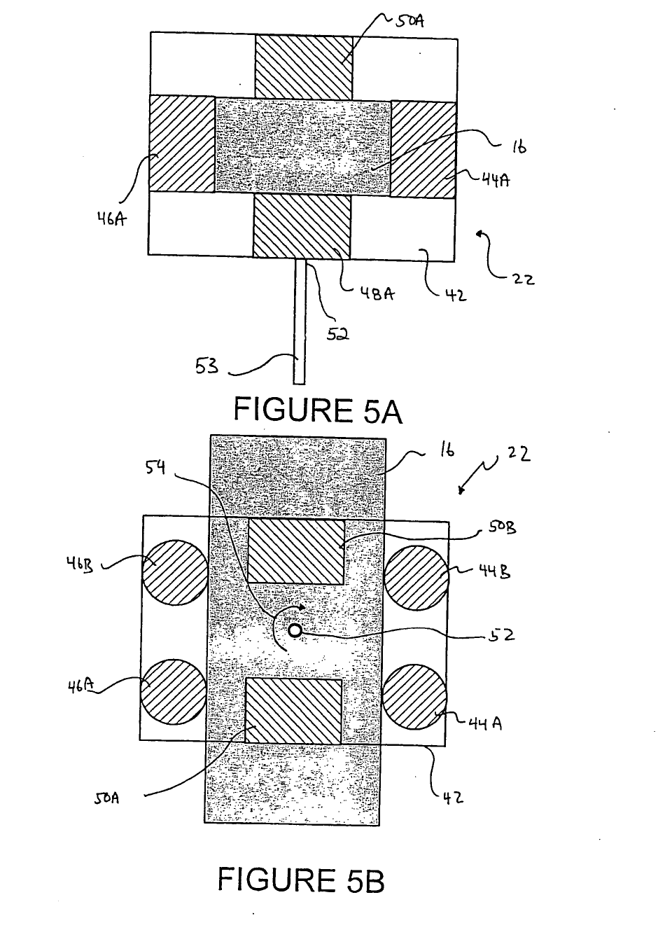

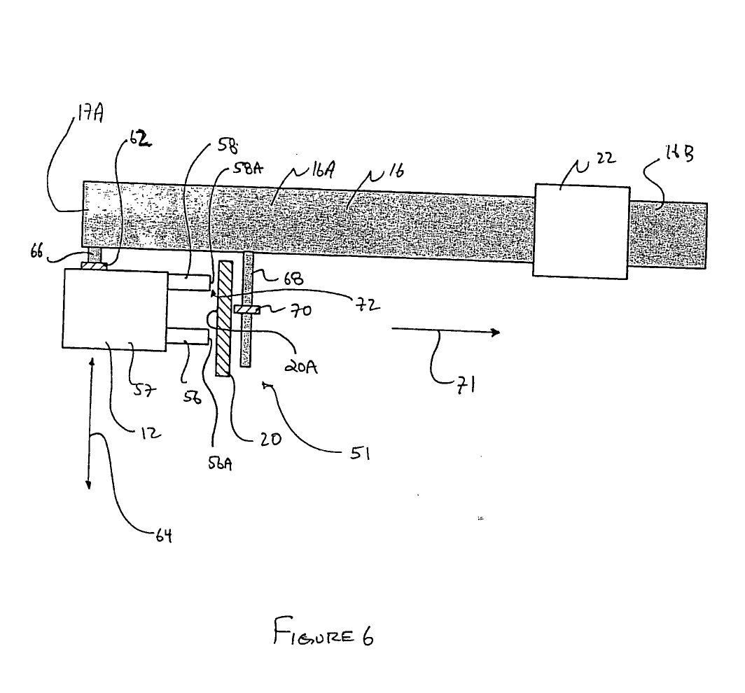

FIG. 5A and 5B are respectively radial and top cross-sectional views of one possible embodiment of sliding/pivoting joint 22. In the illustrated embodiment, joint 22 comprises a housing 42 which accommodates a plurality of bearings 44, 46, 48, 50. Bearings 44, 46, 48, 50 facilitate sliding movement of rod 16 through housing 42. The plurality of bearings includes a first pair of vertical bearings 44A, 44B on one side of rod 16, a second pair of vertical bearings 46A, 46B on the other side of rod 16, a first pair of horizontal bearings 48A, 48B underneath rod 16 and a second pair of horizontal bearings 50A, 50B atop rod 16.

Sliding/pivoting joint 22 also comprises a pivoting mechanism 52 which facilitates pivotal movement of rod 16 and housing 42 in the direction indicated by arrow 54. Pivot mechanism 52 may comprise any pivot joint known in the art or developed in the future. Preferably, pivot mechanism 52 comprises a low friction pivot joint. Those skilled in the art will appreciate that the embodiment depicted in FIGS. 5A and 5B and described above represents only one possible embodiment of sliding/pivoting joint 22. Mechanism 10 may accommodate a wide variety of other possible embodiments of sliding/pivoting joint 22, which incorporate other types of bearings, other types of sliding mechanisms and/or other types of pivotal mechanisms, provided that joint 22 allows rod 16 to slide therethrough and joint 22 allows rod 16 to pivot about shaft 53.

Preferably, bearings 44, 46, 48, 50 are low friction bearings and pivot mechanism 52 is a low friction mechanism. Those skilled in the art will appreciate that friction caused during sliding motion of rod 16 and or pivotal motion of rod 16 will increase the amount of energy that is required to maintain the angular velocity (ω) of rod 16.

In some embodiments, mechanism 10 may comprise one or more additional stabilizing mechanisms (not shown) which may reduce friction and may reduce play between rod 16 and the components of sliding/pivoting joint 22. Such stabilizing mechanism(s) may comprise castor bearing(s), ball transfer unit(s), ball bearing(s) and the like and may be positioned along the length of rod 16 between joint 22 and primary mass 12 and/or between joint 22 and secondary mass 14. The stabilizing mechanism(s) may bear against a guiding surface on which mechanism 10 is deployed.

As discussed briefly above, rotational motion may be imparted on rod 16 (and primary and secondary masses 12, 14) by an external energy source. In one particular embodiment, the shaft of a motor (not shown) may be coupled through a suitable coupling mechanism to shaft 53 of pivoting mechanism 52 (see FIG. 5A). Suitable coupling mechanisms may comprise, for example: gearing, belt drives, chain drives, sprockets, pulleys and the like. The mechanism may be chosen to achieve a desired rotational speed (ω) for rod 16. Rotation of shaft 53 may then cause corresponding rotation of pivot joint 52 (and rod 16) in the direction of arrow 54 (see FIG. 5B).

As mentioned above, primary mass 12 is coupled to primary guide 20, so as to move along primary orbit 18. FIG. 6 is a partially cross-sectioned view of a coupling mechanism 51 which couples primary end 17A of rod 16 and primary mass 12 to primary guide 20 according to a particular embodiment of the invention. In the FIG. 6 embodiment of coupling mechanism 51, primary mass 12 is coupled to portion 16A of rod 16 via a pivot bearing 62 located on downwardly extending arm 66. Pivot bearing 62 permits pivotal movement of primary mass 12 about axis 64. Preferably, pivot bearing 62 is a low friction bearing. In the illustrated embodiment, primary mass 12 comprises a magnet 57 having a first pole 56 and a second pole 58 which extend inwardly toward primary guide 20. The pivotal movement of primary mass 12 (provided by pivot bearing 62) may enable poles 56, 58 to extend substantially orthogonally to the curvature of primary guide 20 during motion of primary mass 12 about primary orbit 18. In alternative embodiments, pivot bearing 62 may be removed and primary mass 12 may be statically coupled to portion 16A of rod 16.

In the illustrated embodiment, a guide bearing 70 is provided on downwardly extending arm 68. When primary mass 12 is in either of angular regions 35, 39 (see FIGS. 1-3) and reaction forces (Fᵣ) are directed outwardly, these reaction forces (Fᵣ) may be borne by guide bearing 70. Preferably, primary guide 20 comprises magnetically permeable material, such that magnet 57 of primary mass 12 tends to pull rod 16 radially inwardly in the direction of arrow 71, thereby reducing the friction experienced by guide bearing 70. Although not depicted in the schematic diagram of FIG. 6, the ends 56A, 58A of poles 56, 58 may be contoured to match the curvature of the outer surface 20A of primary guide 20 to further reduce friction.

Preferably, the gap 72 between the ends 56A, 58A of poles 56, 58 and the outer surface 20A of primary guide 20 is made to be relatively small, so that the force exerted by magnet 57 to pull primary mass 12 radially inwardly toward primary guide 20 may be optimized. In general, however, it is undesirable for poles 56, 58 to contact primary guide 20, because such contact would increase friction within mechanism 10.

To reduce contact between poles 56, 58 and primary guide 20, a separate secondary guide (not shown) may be provided for secondary mass 14. The orbital shape of the secondary guide is different than the orbital shape of the primary guide 20. However, the orbital shape of the secondary guide will be dictated by the orbital shape of primary guide 20 together with the length of rod 16. The secondary guide and the coupling mechanism between the secondary guide and secondary mass 14 may be constructed in a manner similar to primary guide 20 and coupling mechanism 51 between primary guide 20 and primary mass 12. The gap between the secondary guide and the secondary mass guide bearing may be made smaller than the gap 72 between primary guide 20 and poles 56, 58. In this manner, contact between poles 56, 58 and primary guide 20 may be prevented by the secondary mass guide bearing, which will contact the inward side of the secondary guide before poles 56, 58 contact the outward side of primary guide 20.

Those skilled in the art will appreciate that coupling mechanism 51, primary mass 12, rod 16 and/or primary guide 20 may comprise additional magnets (not shown) to optimize the inwardly directed magnetic force which tends to pull primary mass 12 toward primary guide 20 and to minimize the friction experienced by guide bearing 70. In addition, coupling mechanism 51 may be provided with multiple guide surfaces (not shown) and multiple guide bearings (not shown) to further reduce the friction associated with rotational movement of rod 16 and primary mass 12.

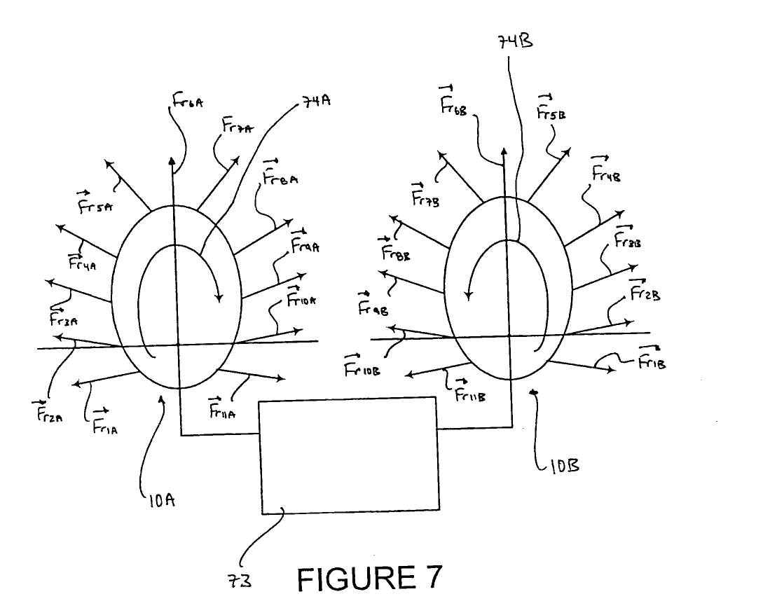

For some applications, such as propulsion for example, it is desirable to have all of the components of reaction force (Fᵣ) oriented in a desired direction, to provide acceleration of mechanism 10 in the desired direction. This may be accomplished by coupling a pair of counter-rotating mechanisms 10A, 10B to a common body 73, as shown schematically in FIG. 7. Mechanism 10A includes a rod, a primary mass and a secondary mass (not shown in FIG. 7) that rotate about point 22A in the clockwise direction indicated by arrow 74A. Mechanism 10B includes a rod, a primary mass, and a secondary mass (not shown in FIG. 7) that rotate about point 22B in the counterclockwise direction indicated by arrow 74B.

If ΘA and ΘB are defined to be the angular coordinates of the primary masses of mechanisms 10A and 10B respectively, then the rods and masses of mechanisms 10A, 10B may be configured to satisfy the condition, ΘA=360 degrees−ΘB (“Equation (5)”). If the rods and masses of mechanisms 10A, 10B satisfy this condition, then the transverse components of the reaction forces (Fᵣₙ) from mechanisms 10A, 10B will substantially cancel one another, resulting in reaction force components (Fᵣₙ) that are primarily oriented at the angular coordinate of 0 degrees. For example, when ΘA is approximately 290 degrees, there will be an outwardly directed reaction force F_{r3A} created by mechanism 10A. At the same time, if Equation (5) is satisfied, then ΘB will be 70 degrees and mechanism 10B will generate an outwardly directed reaction force F_{r3B}. If the magnitude and timing of reaction forces F_{r3A}, F_{r3B} are substantially equal, then the transverse components of these vectors will cancel one another, leaving only reaction force components directed at the angular coordinate of 0 degrees.

As the primary mass of mechanism 10A continues to move in the clockwise direction of arrow 74A, ΘA will eventually reach the angular coordinate of approximately 20 degrees, resulting in reaction force F_{r7A}. At the same time, if the primary mass of mechanism 10B continues to move in the counterclockwise direction of arrow 74B and Equation (5) is satisfied, then ΘB will be 340 degrees, resulting in reaction force F_{r7B}. Once again, if the magnitude and timing of reaction forces F_{r7A}, F_{r7B} are substantially equal, then the transverse components of these vectors will cancel one another, leaving only reaction force components directed at the angular coordinate of 0 degrees.

One or more mechanisms 10 of the type described above may be used to provide a propulsion apparatus. A propulsion apparatus may be provided by mounting one or more mechanisms 10 of the type shown in FIG. 1 onto the object that is desired to be moved. Over the course of a full rotation, each mechanism 10 contributes a net average reaction force (Fᵣₙₑₜ) in the direction of 0 degrees. This net average reaction force (Fᵣₙₑₜ) will tend to move the apparatus forward (i.e. in the direction of 0 degrees). As discussed above, it may be advantageous to locate inflection point 38 in the region between 0 degrees and 90 degrees and to locate inflection point 40 in the region between 270 degrees and 360 degrees, so that all reaction forces (Fᵣₙ) comprise components directed towards 0 degrees. The propulsion apparatus may be a tractionless propulsion apparatus. As used in this description, “tractionless propulsion” refers to a means for propulsion of an object that does not require friction (e.g. a tire on a road) for propulsion and does not require collection and expulsion of mass (e.g. a jet engine) for propulsion.

In a propulsion apparatus, it is desirable to have a pair of mechanisms to provide smooth acceleration in the desired direction. One or more additional pairs of mechanisms (not shown) may also be provided. Each pair of mechanisms may be configured to rotate in opposite directions as shown in FIG. 7 and described above, except that each pair of mechanisms may be configured so that it is rotationally out of phase with the other pairs of mechanisms. In this manner, a first pair of mechanisms may be in angular regions 35, 39 where they contribute reaction forces (Fᵣ) at the same time that a second pair of mechanisms is in the balanced angular region 37 (see FIGS. 1-3). Configuring multiple pairs of mechanisms in this manner could be used to further smooth out the acceleration of the propulsion apparatus.

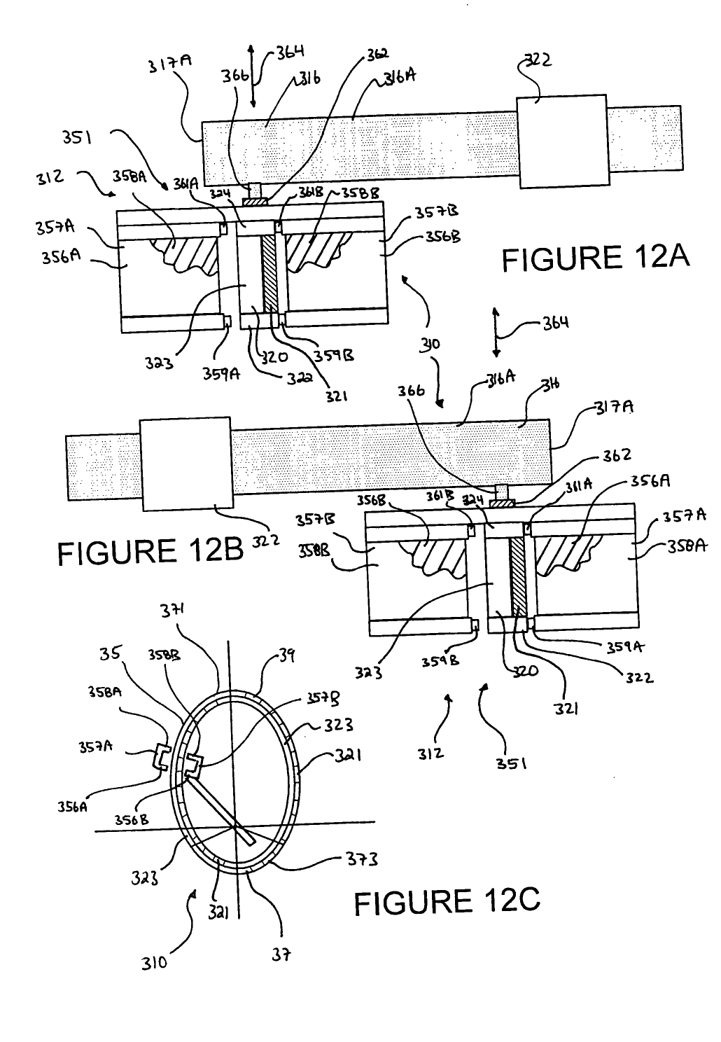

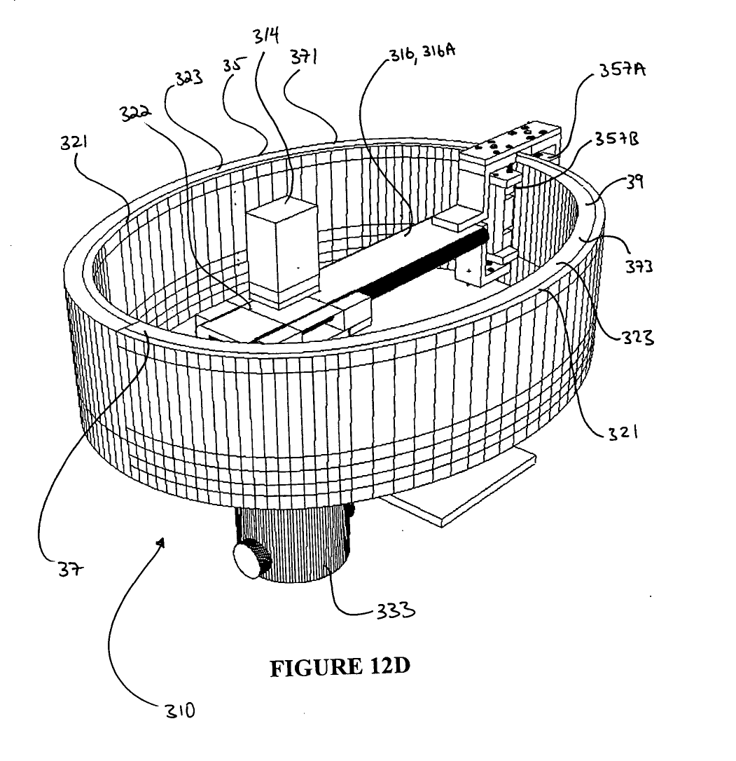

FIGS. 12A-12D depict various views of a mechanism 310 which incorporates a coupling mechanism 351 in accordance with a particular embodiment of the invention. In many respects, mechanism 310 of FIGS. 12A-12D is similar to mechanism 10 depicted described above. Features of mechanism 310 that are substantially similar to features of mechanism 310 are not described further herein.

FIGS. 12A-12C depict partial cut-away cross-sectional views of a coupling mechanism 351 and a corresponding guide 320 suitable for use with mechanism 310 according to another embodiment of the invention. Coupling mechanism 351 couples primary end 317A of rod 316 and primary mass 312 to guide 320. In the embodiment of FIGS. 12A-12D, coupling mechanism 351 and guide 320 are designed to introduce extra energy to the rotational mechanism 310. FIG. 12A depicts coupling mechanism 351 and guide 320 in angular region 35 (see above description of angular region 35) and FIG. 12B depicts coupling mechanism 351 and guide 320 in angular region 39 (see above description of angular region 39).

In the illustrated embodiment of FIGS. 12A-12D, primary mass 312 comprises a pair of magnets 357A, 357B located on the outward and inward side of primary guide 320. Magnets 357A, 357B have poles 356A, 356B, 358A, 358B which extend toward primary guide 320. Poles 356A, 356B, 358A, 358B of magnets 357A, 357B may have ends which are curved to conform with the surface of primary guide 320. In the illustrated embodiment, coupling mechanism 351 comprises a pivot joint 362 located on downwardly extending arm 366 for pivotally coupling primary mass 312 to portion 316A of rod 316. Pivot joint 362 permits pivotal movement of primary mass 312 about axis 364. Preferably, pivot joint 362 is a low friction pivot joint. In some embodiments, coupling mechanism 351 comprises a pair of pivot joints, one such pivot joint corresponding to each of magnets 357A, 357B allowing magnets 357A, 357B to pivot independently with respect to rod 316. Coupling mechanism 351 also comprises a plurality of gapping bearings 359A, 359B, 361A, 361B located on either side of primary guide 320. In the illustrated embodiment of FIGS. 12A-12D, primary mass 312 is provided by magnets 357A, 357B, coupling mechanism 351 and other components located at the primary end 316A of rod 316. In alternative embodiments, primary mass 312 comprises additional weight which may be added to the primary end 316A of rod 316.

In the embodiment of FIGS. 12A-12D, primary guide 320 comprises bearing surfaces 322, 324, a magnetically permeable portion 321 and a non-magnetically permeable portion 323. Preferably, non-magnetically permeable portion 323 is thicker than magnetically permeable portion 321. In angular region 35 (FIG. 12A), magnetically permeable portion 321 is located on the inward side of primary guide 320 and non-magnetically permeable portion 323 is located on the outward side of primary guide 320. Conversely, in angular region 39 (FIG. 12B), magnetically permeable portion 321 is located on the outward side of primary guide 320 and non-magnetically permeable portion 323 is located on the inward side of primary guide 320.

When motor 333 (FIG. 12D) rotates primary mass 312 in a clockwise direction and is located in angular region 35 (FIG. 12A), primary mass 312 will be moving radially outwardly as it rotates. As shown in FIG. 12A, gapping bearings 359B, 361B will respectively contact the inward sides of bearing surfaces 322, 324 to permit primary mass 312 to follow primary guide 320. The dimensions of gapping bearings 359B, 361B and poles 356B, 358B are selected such that when gapping bearings 359B, 361B contact bearing surfaces 322, 324, poles 356B, 358B are brought into close proximity with (but not touching) magnetically permeable portion 321 of primary guide 320. Poles 356B, 358B are attracted to magnetically permeable portion 321.

The magnetic attraction between poles 356B, 358B and magnetically permeable portion 321 provides an outwardly directed magnetic force on rod 316. In the illustrated embodiment of FIGS. 12A, the direction of this outwardly directed magnetic force is substantially orthogonal to the curvature of primary guide 320. In alternative embodiments, magnet 357B or poles 356B, 358B may have different shapes and/or sizes and/or gapping bearings 359B, 361B may have different locations, such that the direction of this magnetic force is oriented in a different direction, such as substantially radially outwardly for example.

A similar inwardly directed magnetic force may be created between poles 356A, 358A and magnetically permeable portion 321. However, as discussed above, non-magnetically permeable portion 323 of primary guide 320 is thicker than magnetically permeable portion 321 and, in angular region 35 (FIG. 12A), poles 356A, 358A are spaced further from magnetically permeable portion 321 than poles 356B, 358B. Accordingly, in angular region 35, the outwardly directed magnetic force created by poles 356B, 358B of magnet 357B is significantly greater than the inwardly directed force created by poles 356A, 358A of magnet 357A.

The net magnetic force, which is outwardly directed in angular region 35, helps to pull primary mass 312 radially outwardly through joint 322 as it moves clockwise along primary guide 320 and thereby provides extra energy to mechanism 310. This extra energy comes from magnet 357B and its attraction to magnetically permeable portion 321 of primary guide 320 and not from motor 333 or other energy source(s) used to rotate mechanism 310 at joint 322.

Similarly, when motor 333 rotates primary mass 312 in a clockwise direction and is located in angular region 39 (FIG. 12B), primary mass 312 will be moving radially inwardly as it rotates. As shown in FIG. 12B, gapping bearings 359A, 361A will respectively contact the outward sides of bearing surfaces 322, 324 to permit primary mass 312 to follow primary guide 320. Accordingly, in angular region 39, poles 356A, 358A are attracted to magnetically permeable portion 321 of primary guide 320. This magnetic force helps to pull primary mass 312 radially inwardly through joint 322 as it moves clockwise along primary guide 320 in angular region 39 and thereby provides extra energy to mechanism 310. This extra energy comes from magnet 357A and its attraction to magnetically permeable portion 321 of primary guide 320 and not from motor 333 or other energy source(s) used to rotate mechanism 310 at joint 322.

FIGS. 12C and 12D respectively illustrate cross-sectional top and isometric views of mechanism 310 showing primary guide 320. Some detail of mechanism 310 has been removed from FIG. 12C for clarity. As shown in FIGS. 12C-12D, primary guide 320 is divided into two halves 371, 373. In half 371 of primary guide 320 (i.e. between 180 degrees and 360 degrees), magnetically permeable portion 321 is located on the inward side of guide 320 and non-magnetically permeable portion 323 is located on the outward side of primary guide 320. Half 371 of primary guide 320 includes angular region 35 (i.e. between 240 degrees and 360 degrees in a preferred embodiment). In half 373 of primary guide 320 (i.e. between 0 degrees and 180 degrees), magnetically permeable portion 321 is located on the outward side of primary guide 320 and non-magnetically permeable portion 323 is located on the inward side of primary guide 320. Half 373 of primary guide 320 includes angular region 39 (i.e. between 0 degrees and 120 degrees in a preferred embodiment). In alternative embodiments, primary guide 320 comprises three separate regions and angular region 37 (i.e. between 120 degrees and 240 degrees in a preferred embodiment) does not comprise any magnetically permeable material.

Those skilled in the art will appreciate that coupling mechanism 351 may also be used as a part of mechanism 10 described above. Coupling mechanism 351 may also be used as a part of any propulsion apparatus described herein which incorporates one or more mechanisms 10, 310. The energy introduced by magnets 357A, 357B may be harnessed and used for a useful purpose. For example, the energy introduced by magnets 357A, 357B may be used to provide additional power to a propulsion mechanism of the type described above, the energy introduced by magnets 357A, 357B may be used to drive a piston or the energy introduced by magnets 357A, 357B may be used as a prime mover for some other mechanical system (e.g. an electrical generator) through some other suitable coupling mechanism. Those skilled in the art will appreciate that there are other uses to which the energy introduced by magnets 357A, 357B may be applied.

Coupling mechanism 351, primary mass 312, rod 316 and/or primary guide 320 may comprise additional magnets to optimize the magnetic forces tending to pull primary mass 312 toward primary guide 320 and to minimize the friction experienced by gapping bearings 359A, 359B, 361A, 361B. In addition, coupling mechanism 351 may be provided with additional guide surfaces and additional guide bearings. As discussed above, the location of gapping bearings 359A, 359B, 361A, 361B relative to poles 356A, 356B, 358A, 358B and relative to one another may be altered to alter the pivotal orientation of coupling mechanism 351 with respect to primary guide 320 and to thereby alter the direction in which the magnetic force is applied between poles 356A, 356B, 358A, 358B and primary guide 320. Similarly, the size and/or shape of poles 356A, 356B, 358A, 358B may be varied to alter the direction in which the magnetic force is applied between poles 356A, 356B, 358A, 358B and primary guide 320. In one particular embodiment, the direction of magnetic force is designed to be radially outwardly in angular region 35 and radially inwardly in angular region 39.

Another aspect of this invention relates to an apparatus for energy extraction that incorporates one or more mechanisms 10, 310 of the various embodiments described above. In accordance with a particular embodiment of the apparatus for energy extraction, kinetic energy is provided to rotate the primary and secondary masses and the rod of a mechanism 10, 310 by a magnetic system comprising specially configured magnets. The magnetic system may comprise permanent magnets. The kinetic energy produced in this manner may be used to generate electricity, for example.

According to the well known work-energy theorem, the change in kinetic energy (ΔKE) of a system is equivalent to the net work (Wₙₑₜ) done on the system. The work-energy theorem may be expressed as, Wₙₑₜ=ΔKE (“Equation (6)”). Referring back to FIGS. 1-3, in order to rotate primary and secondary masses 12, 14 and rod 16, work must be done to move primary mass 12 along primary orbit 18. Mechanism 10 has associated inherent practical energy losses, which arise due to frictional forces etc. Consequently, energy in the form of work must be continually added to mechanism 10 or else these losses will slow the rotation of masses 12, 14 and rod 16 until they eventually come to rest.

Consider FIG. 1, where primary mass 12 is located at an angular coordinate of approximately 320 degrees in angular region 35. When primary mass 12 moves clockwise through angular region 35, primary mass 12 moves both radially outwardly and in a angular direction that is tangential to the curvature of primary orbit 18 at its instantaneous position. As such, the work required to move primary mass 12 along primary orbit 18 comprises two components, which include the work done to move primary mass 12 in the radial direction (W_{rad}=F_{rad}d_{rad}) and the work done to move primary mass 12 in the angular direction (W_{ang}=F_{ang}d_{ang}). F_{rad} and d_{rad} respectively represent the radial component of the force required to move primary mass 12 in the radial direction and the distance that primary mass 12 moves in the radial direction. Similarly, F_{ang} and d_{ang} respectively represent the angular component of the force required to move primary mass 12 in the angular direction and the distance that primary mass 12 moves in the angular direction.

The total work done to move primary mass 12 along primary orbit 18 is then given by the sum of W_{rad} and W_{ang}. The work-energy theorem of Equation (6) may be rewritten as, ΔKE_{primary mass}=W_{rad}+W_{ang}=F_{rad}d_{rad}+F_{ang}d_{ang} (“Equation (7a)”). However, because of the geometry of primary orbit 18, F_{ang} is function of the radial force F_{rad} and the angular position θ of primary mass 12 (F_{ang}=f(F_{rad},θ)). Accordingly, Equation (7a) may be rewritten in the following form: ΔKE_{primary mass}=F_{rad}d_{rad}+f(F_{rad},θ)d_{ang} (“Equation (7b)”). Equation (7b) demonstrates that the kinetic energy of primary mass 12 is a function of the force in the radial direction F_{rad}.

Equation (7b) identifies that providing a force in the radial direction (F_{rad}) may increase the kinetic energy of primary mass 12. In angular region 35, a radially outwardly directed force (F_{rad}) applied to primary mass 12 will cause rod 16 to slide through joint 22, lengthening portion 16A of rod 16 and decreasing portion 16B of rod 16. Because of the geometry of mechanism 10 and, in particular, the geometries of primary orbit 18 and primary guide 20 in angular region 35, a radially outwardly directed force (F_{rad}) applied to primary mass 12 in angular region 35 may also tend to move primary mass 12 in a clockwise circumferential direction around primary guide 20. Similarly, a radially outwardly directed force (F_{rad}) applied to primary mass 12 in angular region 39 may tend to move primary mass 12 in a counterclockwise circumferential direction around primary guide 20. Those skilled in the art will appreciate that inwardly radially directed forces (F_{rad}) will have the opposite effect. Accordingly, the actual circumferential direction in which primary mass 12 will tend to move when it experiences a radially outwardly directed force (F_{rad}) will depend on the location of the primary mass 12 in orbit 18.

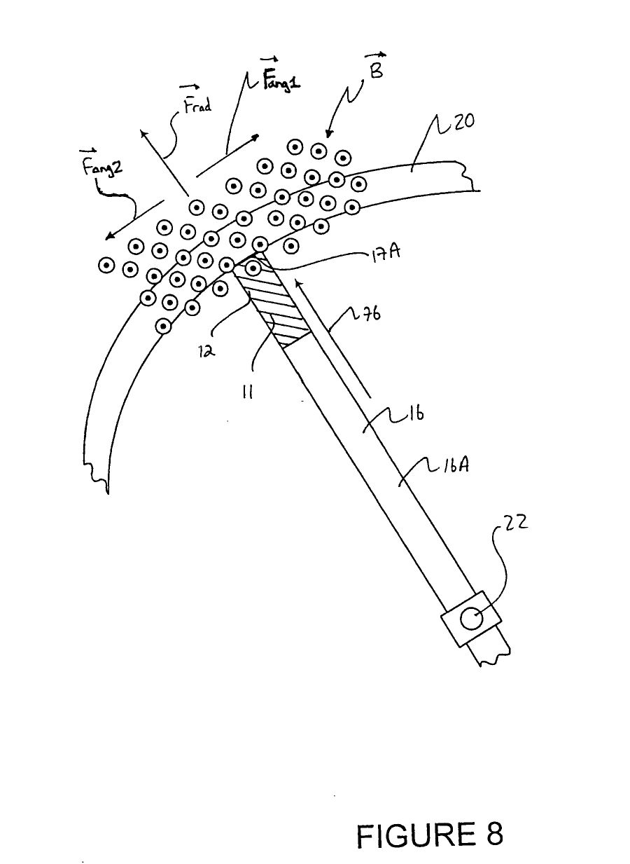

Primary end 17A of rod 16 and/or primary mass 12 may comprise a magnetically permeable material and primary guide 20 may be made magnetic, so as to apply a radially directed force (F_{rad}) to primary end 17A and/or primary mass 12. As shown in FIG. 8, a magnetic field (B) may be provided in the region of primary end 17A of rod 16. The magnetic field (B) may be configured such that it creates a substantially radially oriented force (F_{rad}) on primary mass 12. This force may be approximated by F_{rad}=(1/(2μₒ))∫B²dA (“Equation (8)”), where μₒ is the permeability of free space, B is the magnitude of the magnetic field (B) and the integral is performed over the cross-sectional area (A) of primary end 17A and/or primary mass 12 that contains the magnetically permeable material.

In the illustrated embodiment of FIG. 8, the magnetic field (B) is oriented such that its magnetic flux lines point out of the page. The primary end 17A of rod 16 comprises a magnetically permeable region 11. The force created by magnetic field (B) on magnetically permeable region 11 tends to cause magnetically permeable region 11 to move so as to intercept the maximum possible amount of magnetic flux. Accordingly, the magnetic field (B) creates a pair of angularly oriented forces (F_{ang1}, F_{ang2}) and a radially outwardly directed force (F_{rad}) on magnetically permeable region 11. A magnetic system may be shaped and located such that the angularly oriented forces (F_{ang1}, F_{ang2}) tend to cancel one another out, leaving only the radially oriented force (F_{rad}) acting on magnetically permeable region 11. This outward force (F_{rad}) tends to cause primary end 17A of rod 16 (and primary mass 12) to move radially outwardly in the direction of arrow 76. Primary mass 12 is constrained to move along primary guide 20. As discussed above, primary guide 20 is shaped such that in angular regions 35, 39, circumferential movement of primary mass 12 about primary guide 20 is accompanied by movement of primary mass 12 in the radially direction. Those skilled in the art will appreciate that a radially outwardly oriented force (F_{rad}) which tends to move primary mass 12 radially outwardly also tends to move primary mass 12 in one of the circumferential directions. For example, in angular region 35, a radially outwardly directed force (F_{rad}) tends to move primary mass in a clockwise circumferential direction and in angular region 39, a radially outwardly directed force (F_{rad}) tends to move primary mass in a counterclockwise circumferential direction. Similarly, in angular region 35, a radially inwardly directed force (F_{rad}) tends to move primary mass in a counterclockwise circumferential direction and in angular region 39, a radially inwardly directed force (F_{rad}) tends to move primary mass in a clockwise circumferential direction. As discussed above, this radially outwardly oriented force (F_{rad}) increases the kinetic energy of primary mass 12 in accordance with Equation (7a) and Equation (7b).

In the illustrated mechanisms 10 of FIGS. 1-3, primary orbit 18 (and primary guide 20) have inflection points 38, 40 and transition point 41, as described above. When primary orbit 18 has such a shape, it may be desirable to provide a magnetic system which will provide a magnetic field (B) that is oriented and positioned to create a radially outwardly oriented force (F_{rad}) on primary mass 12 when primary mass 12 is located in angular region 35. In some embodiments, it may also be desirable to provide a magnetic field (B) that is oriented and positioned to create a radially inwardly oriented force (F_{rad}) on primary mass 12 when primary mass 12 is located in angular region 39.

Those skilled in the art will appreciate that a magnetic system could also be designed to provide magnetic fields (B) which are oriented and positioned to create radially oriented forces on secondary mass 14. For example in the illustrated embodiment of FIGS. 1-3, such a magnetic system could provide a magnetic field (B) that is oriented and positioned to create a radially inwardly oriented force (F_{rad}) on secondary mass 14 when primary mass 12 is located in angular region 35 and/or a magnetic field (B) that is oriented and positioned to create a radially outwardly oriented force (F_{rad}) on secondary mass 14 when primary mass 12 is located in angular region 39. Preferably, when primary mass 12 is located in angular region 37, the magnetic system will provide substantially zero magnetic field and, therefore, substantially zero radially oriented force (F_{rad}) on primary mass 12. However, this is not a necessary condition. There may be a small increase in frictional forces if the magnetic system causes a radially oriented force (F_{rad}) in angular region 37. However, this frictional force may be minimized, for example, by optimization of coupling mechanism 51 between primary mass 12 and primary guide 20 (see FIG. 6 and the accompanying description above).

A magnetic system may also be designed to provide one or more magnetic fields (B) which exert force on primary mass 12 and secondary mass 14 at the same or different times during a given rotational orbit. Those skilled in the art will also appreciate that the shape of primary guide 20 may be varied. In particular, the angular coordinates of inflection points 38, 40 and transition point 41 may be varied in accordance with alternative embodiments of the invention.

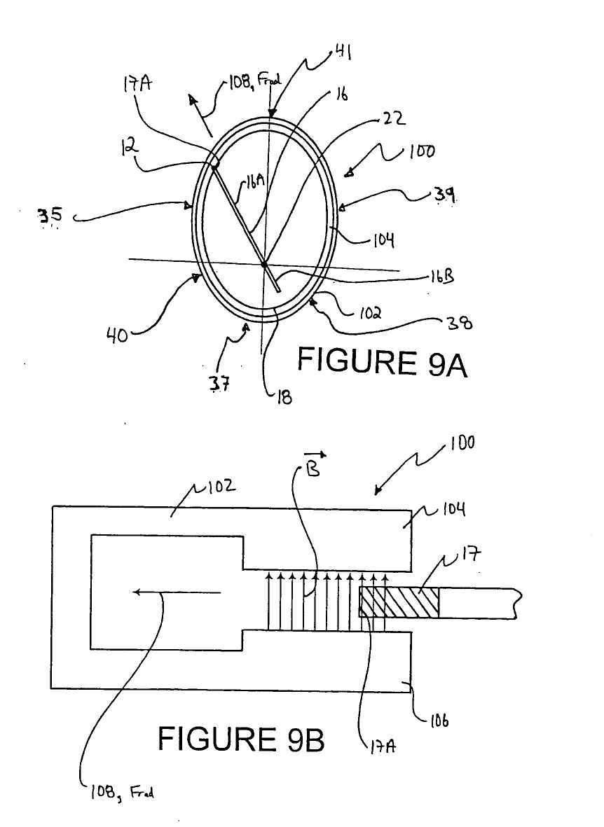

FIGS. 9A and 9B schematically depict one possible embodiment of a magnetic system 100 which can provide the desired magnetic fields (B) and the desired radial forces (F_{rad}) described above. For clarity, a number of features, such as primary guide 20 and masses 12, 14, are not shown in FIGS. 9A and 9B. Magnetic system 100 comprises a permanent magnet 102 that extends 360 degrees around primary orbit 18. Permanent magnet 102 comprises poles 104, 106 which may be positioned such that the magnetically permeable region 11 on primary end 17A of rod 16 extends a small distance between poles 104, 106. It should be understood that the illustrated shape, size and position of magnet 102 is highly schematic and the actual shape may be non-uniform and may vary substantially from that illustrated in FIGS. 9A and 9B.

When primary mass 12 is located in angular region 35, permanent magnet 102 is shaped and located to create a magnetic field (B) which exerts a radially outwardly directed force (F_{rad}) on the magnetically permeable region 11 at the primary end 17A of rod 16. This configuration is illustrated in FIG. 9B, where permanent magnet 102 and its poles 104, 106 are shaped and located to create a magnetic field (B) having flux lines oriented between poles 104, 106. The magnetic field (B) creates a radially outwardly oriented force (F_{rad}) on magnetically permeable region 11. This force (F_{rad}) tends to move magnetically permeable region 11 radially outwardly in the direction indicated by arrow 108, so that magnetically permeable region 11 is immersed in the highest possible amount of flux. In response to this force (F_{rad}), primary end 17A of rod 16 moves radially outwardly in the direction indicated by arrow 108. In accordance with Equation (7b), this radially outwardly oriented force (F_{rad}) provides kinetic energy to primary mass 12.

In the illustrated embodiment of FIGS. 9A and 9B, magnetic system 100 (and more particularly magnet 102) creates radially directed magnetic force in angular region 35 only and creates no radially directed magnetic force in angular region 39 or angular region 37. In order to provide zero magnetic force, magnet 102 and its poles 104, 106 may be shaped and positioned, such that in angular regions 37 and 39, the magnetically permeable region 11 of primary end 17A of rod 16 is immersed in the highest possible amount of magnetic field (B) when primary end 17A is located in one of these regions. In some alternative embodiments, magnetic system 100 is designed to provide inwardly radially oriented force on primary end 17A of rod 16 (or outwardly oriented force on secondary end 17B) when primary end 17A is located in angular region 39.

In the FIG. 9A, 9B embodiment, radially directed magnetic force is only applied in angular region 35. If the kinetic energy provided to primary mass 12 in angular region 35 is sufficient to overcome frictional energy losses in angular regions 37, 39, then rod 16 and masses 12, 14 will continue to rotate in primary orbit 18. Each time that primary mass 12 travels through angular region 35, it will receive additional kinetic energy. Each time that primary mass 12 travels through angular regions 37, 39, some of this kinetic energy will be lost to friction.

Any additional kinetic energy supplied when primary mass 12 travels through angular region 35 may be extracted as rod 16 and masses 12, 14 rotate around primary orbit 18. For example, an apparatus for energy extraction may be provided by coupling sliding/pivoting joint 22 directly (or through a suitable mechanism) to the shaft of a conventional generator. In this manner, the rotation of mechanism 10 may allow sliding/pivoting joint 22 to behave as a prime mover to produce electrical energy.

In an alternative apparatus for energy extraction, a propulsion apparatus of the type described above may be coupled to a moveable moment arm, which is in turn coupled to the shaft of a conventional generator. The movement of the propulsion apparatus may turn the generator shaft to produce electricity. In another alternative embodiment for energy extraction, a coupling mechanism similar to coupling mechanism 351 (FIGS. 12A-12D) is used to impart radially directed forces on primary mass 12 and rod 16. In such embodiments, primary mass 12 comprises the magnets and primary guide 20 comprises the magnetically permeable material. The radially oriented forces created by the coupling mechanism may cause circumferential movement of primary mass 12 as discussed above.

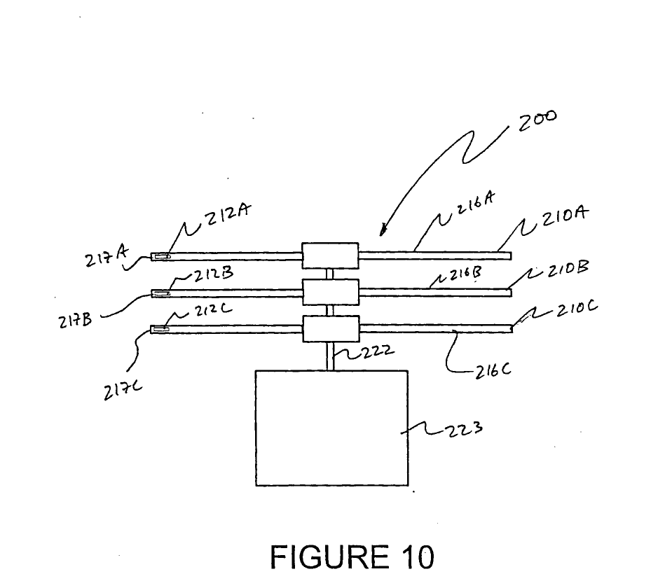

FIG. 10 illustrates an alternative embodiment of an apparatus 200 for energy extraction in accordance with the invention. Apparatus 200 comprises a plurality of mechanisms 210A, 210B, 210C. Each mechanism 210A, 210B, 210C comprises a rod 216A, 216B, 216C and each rod 216A, 216B, 216C has a primary end 217A, 217B, 217C comprising a primary mass 212A, 212B and 212C. Each mechanism 210A, 210B, 210C is coupled to central shaft 222 such that rotation of rods 216A, 216B, 216C cause corresponding rotation of shaft 222. Although not shown in the illustrated embodiment, each mechanism 210A, 210B, 210C is oriented such that it is rotationally out of phase from the adjacent mechanism(s) by an offset angle. In the illustrated embodiment comprising three mechanisms 210A, 210B, 210C, the offset angle is preferably 120 degrees. In alternative embodiments, there may be different number of mechanism(s) and the offset angles may be different.

Each mechanism 210A, 210B, 210C may be provided with a magnetic system (not shown) similar to magnetic system 100 shown in FIGS. 9A and 9B and discussed above or to coupling system 351 shown in FIGS. 12A-12D and discussed above. Because of the angular offset of adjacent mechanisms 210A, 210B, 210C, each mechanism 210A, 210B, 210C is supplied with additional kinetic energy in a different angular region. For example, when mechanism 210A is in its angular region 39 (see FIG. 9A) and may not be receiving any kinetic energy from its associated magnetic system, mechanism 210B may be in angular region 35, where it is receiving kinetic energy from its associated magnetic system. In this manner, shaft 222 may be continually provided with rotational kinetic energy. Shaft 222 may be coupled directly (or through a suitable mechanism (not shown) to a generator 223 as described above to produce electricity. Preferably, magnetic system 200 is designed such that when a particular mechanism (for example, mechanism 210A) is in its angular region 39, its associated magnetic system is shaped and located to create inwardly oriented force on its primary end and/or outwardly oriented force on its secondary end. Such additional forces may help prevent mechanisms 210A, 210B, 210C from binding.

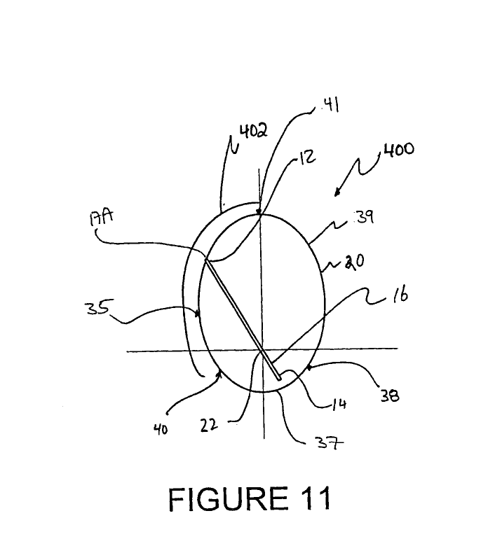

As will be apparent to those skilled in the art in the light of the foregoing disclosure, many alterations and modifications are possible in the practice of this invention without departing from the spirit or scope thereof. For example:
To further reduce friction in mechanism 10, sliding/pivoting joint 22 may be provided with additional magnets (not shown) which reduce the friction associated with the sliding and/or pivoting of rod 16 against bearings 44, 46, 48, 50 and/or against pivot joint 52. Such magnets may be positioned and/or activated to reduce the contact between rod 16 and bearings 44, 56, 48, 50.
An additional or alternative magnetic system for providing the radially oriented forces (F_{rad}) discussed above comprises one or more selectively activatable electromagnetic solenoid(s). Such solenoid(s) may be located at the end(s) of rod 16 and/or in housing 42 of sliding/pivoting joint 22 (see FIGS. 5A, 5B). Such solenoid(s) could be selectively powered to exert radially oriented forces (F_{rad}) on rod 16. Such solenoid(s) may be combined with the other magnetic systems disclosed in this description to increase their efficiency. Such solenoids may also be used in apparatus 200 (FIG. 10) or in mechanism 310 (FIGS. 12A-12D).
Another alternative magnetic system 400 is shown schematically in FIG. 11. Some detail of various components is omitted from FIG. 11 for clarity. Magnetic system 400 is similar to magnetic system 100 of FIGS. 9A, 9B, except that magnet 402 is provided only in angular region 35. In the illustrated embodiment of magnetic system 400, no magnets interact with the primary end 17A of mechanism 10 when primary end 17A is located in angular regions 37, 39. Since magnet 402 ends after angular region 35, there may be some undesired magnetic force which tends to prevent primary end 17A of rod 16 from exiting magnet 402. This undesired magnetic force may be overcome by inertia, for example. Magnetic system 400 may be used in the apparatus 200 of FIG. 10. In such an apparatus, magnets 402A, 402B, 402C could be provided with angular offsets that are similar to those of force extraction systems 210A, 210B, 210C. In such a case, the energy required for a given mechanism (e.g. 210A) to exit an end of its associated magnet 402A may be provided by the kinetic energy gained when an adjacent mechanism 210B enters its associated magnet 402B.
Magnetic system 400 of FIG. 11 may be varied in still further alternative embodiments (not shown) by using another magnet (not shown) to provide additional kinetic energy to rod 16 and masses 12, 14 when primary end 17A is located in angular region 39. Such a system may comprise a magnet (not shown) that is similar to magnet 402, but which acts on secondary mass 14 and provides a radially outwardly oriented force on secondary mass 14 when primary end 17A is in angular region 39. Alternatively, such a system may comprise a magnet shaped and positioned to provide a radially inwardly oriented force on primary end 17A when it is in angular region 39.
The magnetic systems described above could be replaced with electrostatic systems, which use capacitative energy to create radial forces that tend to rotate rod 16 and masses 12, 14. For example, the primary end 17A of rod 16 could be provided with a certain potential (i.e. a voltage) and a suitably shaped and located electrostatic member could be provided with a different potential. This electrostatic potential difference may cause an attractive and/or repulsive force on the primary end 17A of rod 16 in the radial direction. Such radially directed forces may be used to pivot rod 16 as described above and to provide kinetic energy in accordance with Equation (7a) and Equation (7b). In further alternative embodiments, radial forces may be supplied by any of the known forces, including gravity and nuclear forces.
The end(s) 17A, 17B of rod 16 may comprise magnets and the magnetic systems described above may be implemented by providing magnetically permeable materials of suitable size, shape and/or position to exert radially oriented force (F_{rad}) on the magnets of rod 16.
The magnetic systems described above may also incorporate magnetic repulsion to provide the radially oriented forces (F_{rad}).
The magnetic systems described above may be used to rotate mechanisms 10, 310 to provide propulsion apparatus. In propulsion apparatus, such magnetic systems may replace motors which drive sliding/pivoting joint 22 or may be provided in combination with such motors.
In embodiments which incorporate the magnetic systems described above, rotation of mechanism 10 (i.e. primary mass 12 and secondary mass 14) may be controlled by advancing and/or retracting the primary end 17A of rod 16 from within the magnetic field (B). This could be accomplished by making the magnetic systems (or portions thereof) moveable with respect to sliding/pivoting joint 22. For example, rotation of mechanism 10 may be slowed down or stopped by moving magnets outwardly and away from primary end 17A of rod 16 to reduce the system kinetic energy. In alternative embodiments, an electro-mechanical system may be used to control the rotation of mechanism 10. Similar modifications could be used to control the rotation of mechanism 310.

1. An apparatus for converting rotational motion into linear force, the apparatus comprising:
a rod having a primary end and an opposing secondary end, the rod rotatable about a pivot joint and translatable relative to the pivot joint;
a guide coupled to the primary end for constraining motion of the primary end to a particular orbit around the pivot joint, the particular orbit having a first region shaped such that when the primary end is located in the first region, a moment of inertia of the primary end is greater than a moment of inertia of the secondary end; and
an energy introduction mechanism for causing rotation of the rod about the pivot joint;
wherein rotation of the rod about the pivot joint causes unbalanced centripetal forces which result in reaction forces exerted by the primary end on the guide and wherein, over the course of a full rotation, the reaction forces add to provide a linear force in a desired direction.

2. An apparatus according to claim 1 wherein the first region comprises first and second subregions, the first subregion shaped such that as the primary end moves through the first sub-region in a particular direction, a distance between the pivotal joint and the orbit increases and the second subregion shaped such that as the rod moves through the second subregion in the particular direction, a distance between the pivotal joint and the orbit decreases.

3. An apparatus according to claim 2 wherein the energy introduction mechanism comprises a motor coupled to rotate the rod about the pivot joint.

4. An apparatus according to claim 1 wherein the orbit is substantially elliptical in shape and the pivot joint is located at a focal point of the elliptical orbit.

5. An apparatus according to claim 3 wherein the rod comprises a primary mass at the primary end thereof.

6. An apparatus according to claim 5 wherein the rod comprises a secondary mass at the secondary end thereof.

7. An apparatus according to claim 6 wherein the primary mass and the secondary mass are equal.

8. An apparatus according to claim 5 wherein the guide comprises a magnetically permeable material.

9. An apparatus according to claim 8 comprising a coupling mechanism for coupling the primary mass to the guide, the coupling mechanism comprising a bearing in contact with the guide and at least one permanent magnet, the permanent magnet oriented to create a magnetic force on the magnetically permeable material that tends to reduce frictional force between the bearing and the guide over at least a portion of the orbit.

10. An apparatus according to claim 9 wherein the coupling mechanism comprises a pivotal joint for allowing pivotal motion of the primary mass with respect to the primary end.

11. An apparatus according to claim 9 wherein the bearing contacts the guide on an inward surface thereof and the permanent magnet is located on an outward side of the guide.

12. An apparatus according to claim 3 comprising a coupling mechanism for coupling the primary mass to the guide, the coupling mechanism comprising an outward permanent magnet located on an outward side of the guide, an inward permanent magnet located on an inward side of the guide, at least one outward bearing in contact with the outward side of the guide for a first portion of the orbit and at least one inward bearing in contact with the inward side of the guide for a second portion of the orbit.

13. An apparatus according to claim 12 wherein the guide comprises a magnetically permeable material, the magnetically permeable material located on an outward side of the guide in a first portion of the guide corresponding to the first portion of the orbit and the magnetically permeable material located on an inward side of the guide in a second portion of the guide corresponding to the second portion of the orbit.

14. An apparatus according to claim 13 wherein the guide comprise a non-magnetically permeable material having a thickness greater than the magnetically permeable material, the non-magnetically permeable material located on an inward side of the guide in the first portion of the guide and the non-magnetically permeable material located on an outward side of the guide in the second portion of the guide.

15. An apparatus according to claim 14 wherein the coupling mechanism comprises a pivotal joint for allowing pivotal motion of the primary mass with respect to the primary end.

16. An apparatus according to claim 14 wherein the inward and outward permanent magnets introduce kinetic energy to the primary mass that is independent of a kinetic energy due to rotation of the primary mass about the orbit.

17. An apparatus according to claim 16 wherein the primary mass is coupled to a secondary mechanism for harnessing the kinetic energy introduced by the inward and outward permanent magnets.

18. An apparatus according to claim 17 wherein the secondary mechanism comprises a moment arm of a generator.

19. An apparatus according to claim 1 wherein the apparatus is coupled to a secondary mechanism powered by the linear force.

20. An apparatus according to claim 1, wherein the apparatus is one of a plurality of apparatus according to claim 1 connected to a common body of a propulsion mechanism.

21. An apparatus for extracting energy from a magnetic field using rotational motion, the apparatus comprising:
a rod having a primary end and an opposing secondary end, the rod rotatable about a pivot joint and translatable relative to the pivot joint; and
a guide coupled to the primary end for constraining motion of the primary end to a particular orbit around the pivot joint, the particular orbit having a first region shaped such that when the primary end is located in the first region, a moment of inertia of the primary end is greater than a moment of inertia of the secondary end;
wherein the primary end comprises a magnetically permeable material and the guide comprises one or more permanent magnets located to span at least a portion of the orbit, the one or more permanent magnets shaped to exert a radially directed force on the primary end, the radially directed force causing the primary end to rotate about the pivot joint and to thereby move about the orbit.
